(19) United States
(12) Patent Application Publication
(10) Pub. No.: US 2008/0239899 A1
(43) Pub. Date: Oct. 2, 2008

(54) OPTICAL DISK DRIVE

(75) Inventor: Keishi Ueno, Iruma-shi (JP)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TEAC CORPORATION, Tokyo (JP)

(21) Appl. No.: 12/055,211

(22) Filed: Mar. 25, 2008

(30) Foreign Application Priority Data
Mar. 27, 2007 (JP) 2007-081976

(51) Int. Cl. G11B 5/00

(52) U.S. Cl. 369/47.53

(57) ABSTRACT

An optical disk drive sets optimum recording power responsive to recording linear speed. When data are recorded in an optical disk, data are managed for each recording unit block (RUB). An APC area is provided at the top of RUBs, and OPC is performed by use of the APC area, whereby optimum recording power responsive to recording linear speed is set. Tentative optimum recording power responsive to recording linear speed is set, and test data are written, for a try, in the APC area at recording power that is determined by increasing or decreasing the tentative optimum recording power by a trace amount. The optimum recording power is set in according with a β value obtained as a result of reproduction of the test data.

### PRIORITY INFORMATION

This application claims priority to Japanese Patent Application No. 2007-081976 filed on Mar. 27, 2007, which is incorporated herein by reference in its entirety.

### BACKGROUND

1. Technical Field

The present invention relates to an optical disk drive, and more particularly to control of recording power.

2. Related Art

Control of recording power is indispensable when data are recorded in a recordable optical disk, such as a CD-R, a DVD±R, and a BD-R.

In normal times, when optimum recording power is determined, data are written, for a try, in a PCA (Power Calibration Area), which is prepared along an inner radius of an optical disk, by means of stepwise recording power. A value β of a reproduced signal is measured by reproducing the thus-written data, and recording power at which a target value β is obtained is determined to optimum recording power.

Incidentally, as in the case of CAV (constant angular velocity) recording and ZCLV (zone CLV: constant linear velocity per zone) recording, there is a case where recording linear velocity achieved along an outer radius differs from recording linear speed achieved along an inner radius. For instance, there are a case where 16× speed is achieved along the innermost radius and where 40× speed is achieved along the outermost radius. When the dependence of recording power on linear velocity is high, there arises a case where optimum recording power determined by use of the PCA located along the inner radius does not always become optimum at the outer radius.

Accordingly, optimum recording power obtained at the PCA located along the inner radius has hitherto been multiplied by a constant K determined for each double recording speed of a target area, thereby determining optimum recording power for that area.

JP 2002-157738A describes an optical disk drive that rotates at constant angular velocity a disk having, from an inner radius toward an outer radius, a trial write area, a buffer area, a lead-in area, a program area, and a lead-out area. In the optical disk drive, a test signal is recorded in an outer area located outside the trial write area and the lead-out area, and there is performed operation for setting a laser output value by reproducing the thus-recorded test signal.

However, setting a constant K for each medium, for each drive, and for each velocity greatly affects the number of design processes and the number of production processes. Hence, in reality, the operations are performed in a simplified manner by limiting the operations for typical mediums. The method also encounters in difficulty in address variations in the sensitivity of a medium in the market. Moreover, a recording characteristic becomes more sensitive to recording power with an increase in the volume of data in a CD-R, a DVD±R, and a BD-R. Making recording power optimum for target double recording speed or recording linear velocity becomes important more and more, and higher accuracy has been requested.

### SUMMARY

The present invention provides an apparatus capable of recording data at optimum recording power even when double recording speed or recording linear velocity is not constant.

The present invention is directed toward an optical disk drive that records data in each predetermined recording block which includes an APC area for use in controlling power, the drive comprising:

an irradiation section for emitting a recording laser beam; and

a power control section that emits the recording laser beam to the APC area of the recording block, to thus write test data for a try, and that controls recording power of the recording laser beam in accordance with quality of a reproduced signal obtained as a result of reproduction of the test data.

According to the present invention, recording power control; namely, so-called OPC (Optimum Power Control), is performed by use of an APC area. Hence, recording power can be optimized highly accurately without decreasing the volume of a user data area.

The invention will be more clearly comprehended by reference to the embodiment provided below. However, the following embodiment is merely illustrative, and the scope of the invention is not limited to the embodiment.

### BRIEF DESCRIPTION OF THE DRAWINGS

A preferred embodiment of the present invention will be described in detail by reference to the following drawings, wherein:

FIG. 1 is a block diagram of an entire optical disk drive;

FIG. 2 is a recording format diagram;

FIG. 3 is a descriptive view of APC operation performed in an APC area of an RUB (recording unit block);

FIG. 4 is a graph showing a relationship between a drive current and amounts of light emission;

FIG. 5 is a processing flowchart of an embodiment;

FIG. 6 is a descriptive view of performance of OPC in an APC area;

FIG. 7 is a descriptive view of a position where an OPC area (an APC area) is present;

FIG. 8 is a descriptive view showing a relationship between the OPC area (the APC area) and ranges A through E; and

FIG. 9 is a table showing the relationship between the OPC area (the APC area) and the ranges A through E.

### DETAILED DESCRIPTION

An embodiment of the present invention will be described below by reference to the drawings.

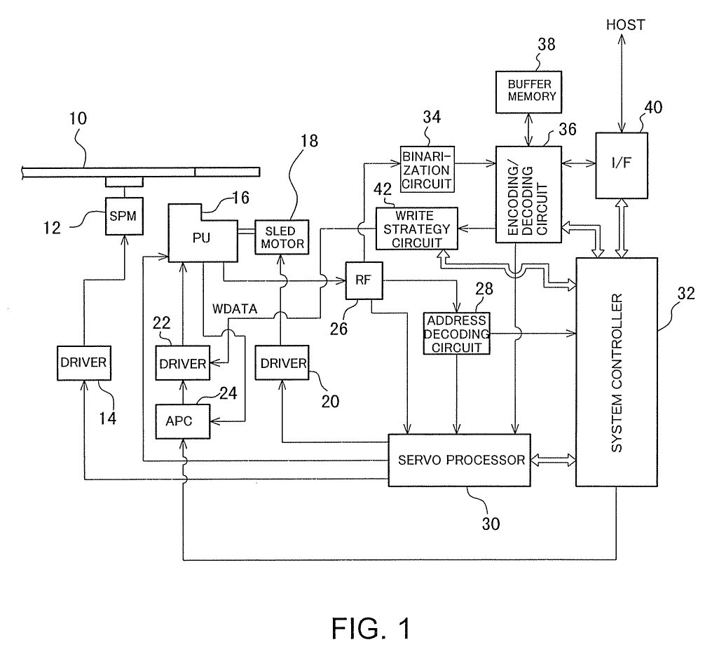

FIG. 1 is a block diagram of an entire optical disk drive of the embodiment. A data-recordable optical disk 10, such as a BD-R (Blu-ray), is rotationally driven by a spindle motor (SPM) 12. The spindle motor SPM 12 is driven by a driver 14, and the driver 14 is servo-controlled by a servo processor 30 so as to attain a desired rotational speed.

The optical pickup 16 includes a laser diode (LD) for radiating a laser beam onto the optical disk 10 and a photodetector (PD) that receives light reflected from the optical disk 10 and converts the thus-received light into an electric signal; and is disposed opposite the optical disk 10. The optical pickup 16 is driven in a radial direction of the optical disk 10 by means of a sled motor 18, and the sled motor 18 is driven by a driver 20. As is the case with the driver 14, the driver 20 is servo-controlled by the servo processor 30. The LD of the optical pickup 16 is driven by a driver 22, and the driver 22 is controlled by an automatic power control circuit (APC) 24 in such a way that a drive current comes to a desired value. The APC 24 and the driver 22 control amounts of light emission from the LD under an instruction from a system controller 32. In the drawing, the driver 22 is provided separately from the optical pickup 16, but the driver 22 may also be incorporated into the optical pickup 16, as will be described later.

When data recorded in the optical disk 10 are reproduced, a laser beam of reproducing power is emitted from the LD of the optical pickup 16; resultant reflected light is converted into an electric signal by the PD; and the electric signal is output. A reproduced signal from the optical pickup 16 is fed to an RF circuit 26. The RF circuit 26 generates from the reproduced signal a focus error signal and a tracking error signal and feeds the thus-generated signals to the servo processor 30. In accordance with these error signals, the servo processor 30 servo-controls the optical pickup 16, thereby maintaining the optical pickup 16 in on-focus and on-track states. Moreover, the RF circuit 26 feeds an address signal included in the reproduced signal to the address decoding circuit 28. The address decoding circuit 28 demodulates address data pertaining to the optical disk 10 from the address signal and feeds the thus-demodulated address data to the servo processor 30 and the system controller 32.

An example of the address signal is a wobble signal. Tracks of the optical disk 10 are wobbled by means of a modulation signal of time information representing the absolute address of the optical disk 10. A resultant wobble signal is extracted from a reproduced signal, and the thus-extracted wobble signal is decoded, so that address data (ATIP) can be obtained.

The RF circuit 26 feeds a reproduced RF signal to a binarization circuit 34. The binarization circuit 34 binarizes the reproduced signal and feeds the thus-acquired signal to an encoding/decoding circuit 36. The encoding/decoding circuit 36 subjects the binarized signal to demodulation and error correction, to thus acquire reproduced data. The reproduced data are output to a host machine, such as a personal computer, by way of an interface I/F 40. When the reproduced data are output to the host machine, the encoding/decoding circuit 36 outputs the reproduced data after temporarily storing the data in buffer memory 38.

When data are recorded in the optical disk 10, data to be recorded transmitted from the host machine are fed to the encoding/decoding circuit 36 by way of the interface I/F 40. The encoding/decoding circuit 36 stores in the buffer memory 38 the data to be recorded; encodes the data to be recorded; and feeds the thus-encoded data as modulated data to a write strategy circuit 42. In accordance with a predetermined recording strategy, the write strategy circuit 42 converts the modulated data into a multipulse (a pulse train), and feeds the multipulse as record data to the driver 22. Since the recording strategy affects recording quality, the recording strategy is usually fixed to a certain optimum strategy. The laser beam whose power is modulated by the record data is emitted from the LD of the optical pickup 16, whereupon data are recorded in the optical disk 10. After recording of data, the optical pickup 16 radiates a laser beam of reproducing power, thereby reproducing the record data; and feeds the record data to the RF circuit 26. The RF circuit 26 feeds a reproduced signal to the binarization circuit 34, and the thus-binarized data are fed to the encoding/decoding circuit 36. The encoding/decoding circuit 36 decodes the modulated data and verifies the thus-decoded data against record data stored in the buffer memory 38. A result of verification is fed to the system controller 32. The system controller 32 determines whether to continually record data in accordance with the result of verification or to perform alternating operation.

The system controller 32 controls operation of the entire system, to thus particularly effect OPC. During OPC, test data are written, for a try, in the PCA of the optical disk 10 while recording power is changed stepwise. The test data thus written for a try are reproduced, and a β value, a γ value, the degree of modulation, an error rate, and the like, of the reproduced data are measured. Recording power at which the quality of the reproduced signal, such as an error rate, comes to a desired value is selected and taken as optimum recording power Po (optimum recording power achieved along an inner radius). The system controller 32 controls the driver 22 in such a way that the selected recording power Po is attained. Moreover, in consideration of the fact that double recording speed or recording linear speed of the optical disk 10 changes at an in-plane position, the system controller 32 computes optimum recording power responsive to the double recording speed or the recording linear speed (i.e., optimum recording power achieved at arbitrary recording linear speed).

Processing for computing optimum recording power performed in the system controller 32 will be described hereinbelow by means of taking a blu-ray disk as an example of the optical disk 10.

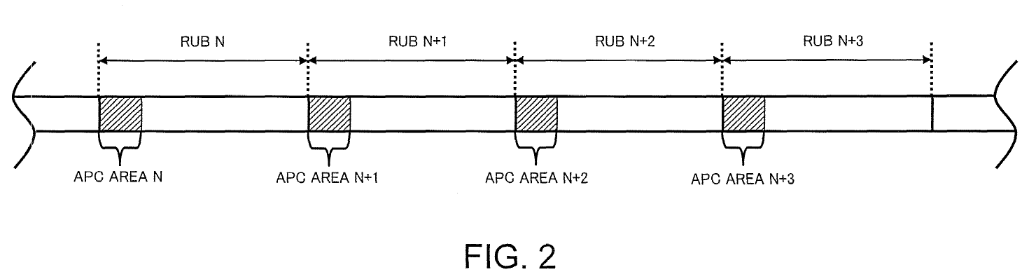

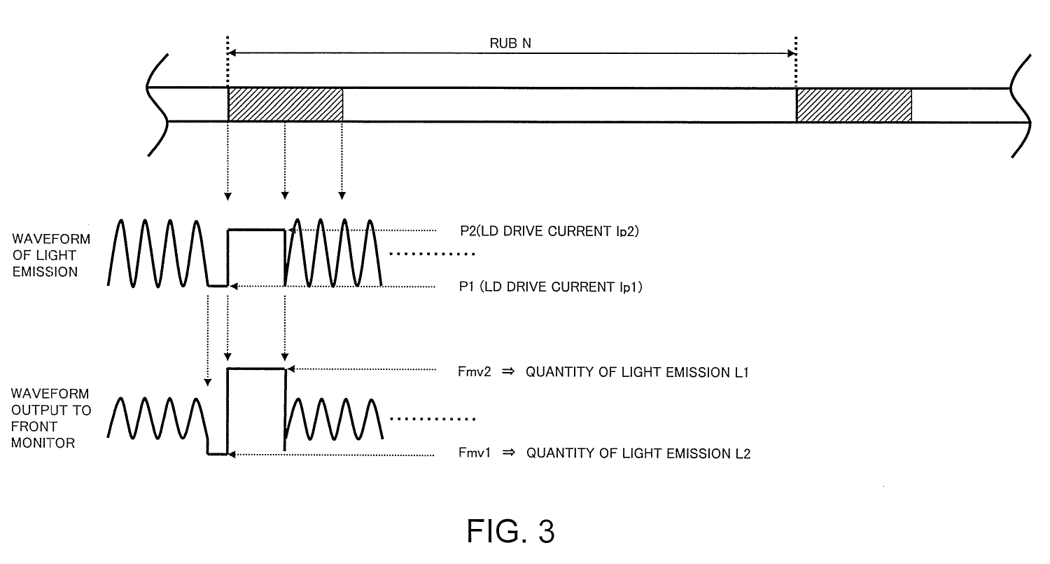

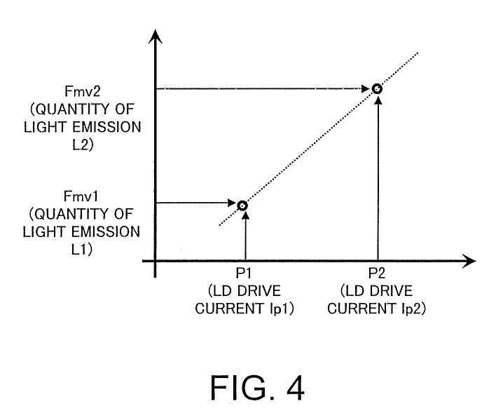

In a blu-ray disk, data are managed for each recording unit block (RUB). A single RUB comprises a run-in section (Runin section) of 2760 channel bits (cbs); a physical cluster (Physical Cluster) of 496×1932 channel bits; and a run-out section (Runout section) of 1104 channel bits. The physical cluster is a user data area. As shown in FIG. 2, an APC area is provided in the head of the RUB consisting of the run-in section, the physical cluster, and the run-out section; specifically, the top run-in section. The APC area corresponds to five wobbles (i.e., 5×69 channel bits), and APC is performed through use of this area. The word “APC” signifies that a drive current, at which a desired quantity of light emission can be acquired, is controlled by means of computing a relationship between an electric current (i) and the quantity of light emission (L), because a light emission characteristic of the laser diode (LD) exhibits temperature dependence and because the quantity of light emission can change even at the same drive current. As shown in FIG. 3, by use of the APC area, light emission quantities Fmv1 and Fmv2 are detected on a front monitor by means of changing a drive current in two steps Ip1 and IP2. As shown in FIG. 4, there is performed processing for computing a relationship between the drive current and the quantities of light emission (linear approximation in the drawing) and computing a drive current at which a desired quantity of light emission is achieved. For instance, the LD is driven at 5 mW and 15 mW, and quantities of light emission achieved at these electric currents are detected by means of the front monitor disposed in the vicinity of the LD; and an i-L characteristic of the LD is learned or corrected.

In the present embodiment, attention is paid to the APC area, and OPC is performed by use of the APC area in order to compute optimum recording power responsive to double recording speed or recording linear speed achieved at that position.

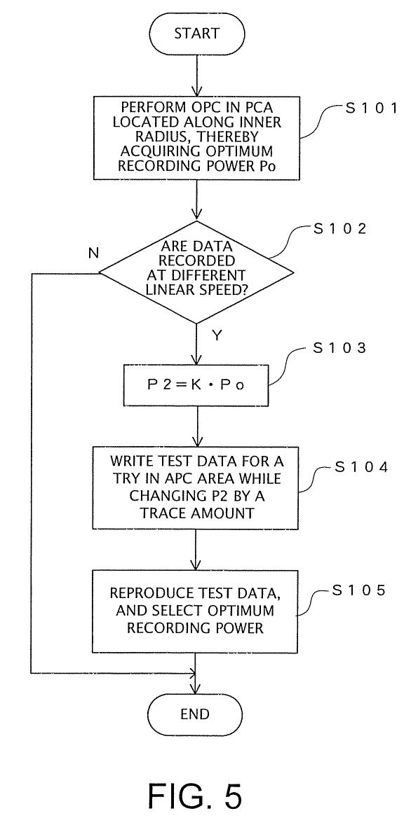

FIG. 5 shows a flowchart of recording power control processing of the present embodiment. First, the system controller 32 performs OPC by use of a PCA previously prepared along the innermost radius of the optical disk 10, thereby acquiring optimum recording power Po and storing the thus-acquired power in memory (nonvolatile memory such as flash ROM) (S101). Specifically, test data are written, for a try, in the PCA by means of a plurality of levels of recording power by changing the recording power stepwise. Quality of a reproduced signal obtained as a result of reproduction of the test data; for example, a β value, is measured, and recording power at which desired quality for a reproduced signal is obtained is set to the optimum recording power Po.

Next, a determination is made as to whether data are recorded at the same recording linear speed as that achieved in the PCA located along the innermost radius or at different recording linear speed (S102). Data are recorded at different recording linear speed in a CAV or a ZCLV, whereas data are recorded at the same recording linear speed in a CLV. When data are recorded at the same recording linear speed, the essential requirement is to record data over the entire disk at the optimum recording power Po set in S101. In contrast, when data are recorded at different recording linear speed, tentative optimum recording power P2 responsive to recording linear speed for an area where data will be recorded is first computed. Specifically, tentative optimum recording power is computed from P2=K·Po by use of a constant K set responsive to the recording linear speed for the area where data will be recorded (S103). The constant K is previously determined for each recording linear speed and stored in memory. Alternatively, the constant K may also be computed like; for example, K=(V2/V1)^{0.5}, by use of a ratio of recording linear speed V2 for an area where data will be recorded and the recording linear speed V1 for the PCA.

After tentative optimum recording power P2 is computed in accordance with the recording linear speed for the area where data will be recorded, test data are written for a try while the power P2 is changed, by trace amounts, through use of the APC area located at the top of RUBs of that area (S104). For instance, test data are written, for a try, in a total of five APC areas located at the top of five RUBs at five recording power levels; namely, 80% of the recording power P2, 90% of the recording power P2, the recording power P2, 110% of the recording power P2, and 120% of the recording power P2. The test data may also be a random pattern or a fixed pattern, such as an iterative pattern consisting of the shortest data length T and the longest data length T. After the test data are written in the APC area for a try, the test data are reproduced, and the quality of a reproduced signal, such as a β value, is measured. Power at which desired quality for the reproduced signal is achieved is set to optimum recording power at the recording linear speed for that area (S105). Through forgoing processing, optimum recording power for an arbitrary area on the optical disk 10 can be computed.

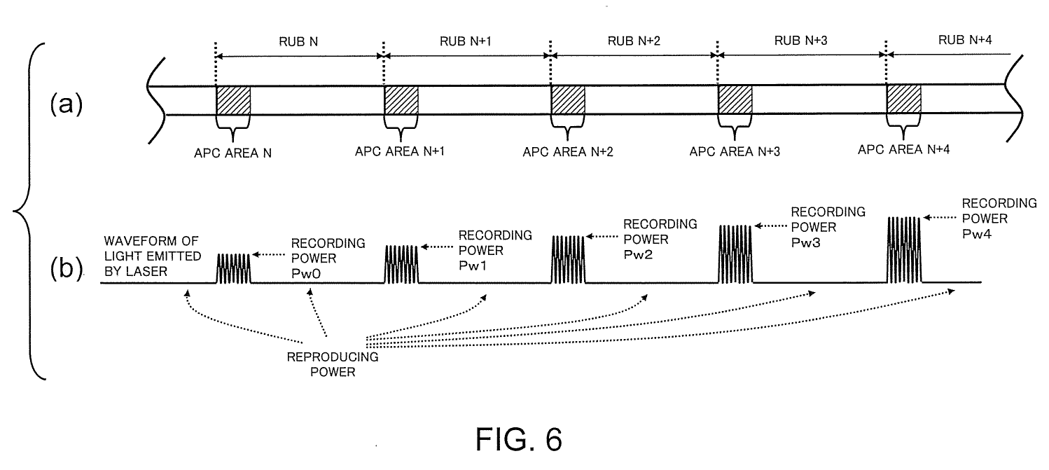

FIG. 6 shows the manner in which test data are written for a try in the respective five APC areas. Five APC areas APC area N to APC area N+4 are present. Test data are written for a try in the APC area N at recording power of Pw0=0.8 P2; test data are written for a try in the APC area N+1 at recording power of Pw1=0.9 P2; test data are written for a try in the APC area N+2 at recording power of Pw2=P2; test data are written for a try in the APC area N+3 at recording power of Pw3=1.1 P2; and test data are written for a try in the APC area N+4 at recording power of Pw4=1.2 P2. Since the APC areas are provided separately from an area where user data are recorded, the volume of the user data area does not change even when test data are written for a try in the APC areas.

The APC areas of the RUBs are originally areas where APC is to be performed. However, as mentioned previously, APC is for detecting the quantity of light emission of the LD on the front monitor in order to determine the relationship between the drive current of the LD and the quantity of light emission. The nature of data to be recorded in the APC area or the nature of data recorded in the APC area is irrelevant to APC. The reason for this is that the quantity of light emission from the LD is detected simply on the front monitor during APC rather than data recorded in the optical disk being reproduced. Therefore, even when test data are written for a try in the APC area as in the present embodiment; in other words, even when the APC area is used also as a PCA intended for performing OPC, original APC operation is not affected at all.

In the present embodiment, tentative optimum recording power P2 responsive to the recording linear speed of an area where data are to be recorded is computed from the optimum recording power Po for the PCA, and test data are written for a try by means of changing the tentative optimum recording power P2 by only trace amounts. However, the tentative optimum recording power P2 may also be determined previously for each recording linear speed without use of the optimum recording power Po, and the thus-determined power may also be stored in memory.

In the present embodiment, OPC is performed through use of the five consecutive APC areas; namely, the APC are N to the APC area N+4, as shown in FIG. 6. However, use of consecutive APC areas is not always needed, and a plurality of arbitrary or discrete APC areas can be used. In this case, selecting a plurality of APC areas where OPC is to be performed in consideration of positions of the areas on an optical disk is preferable. For the sake of convenience, descriptions will be provided below on the assumption that an APC area is taken as an OPC area, because OPC is performed in the APC area.

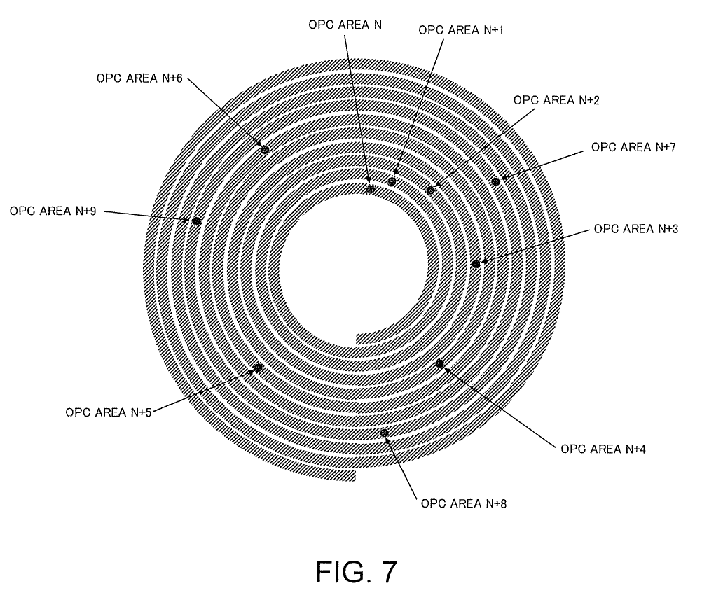

As shown in FIG. 7, when OPC area N (analogous to an APC area N) to OPC area N+9 are present and when OPC is performed by use of a total of five OPC areas; i.e., the OPC area N to an OPC area N+4, all of the OPC area N to the OPC area N+4 are present in a right half of the optical disk. Hence, OPC is performed by use of only the right half of the optical disk. When a right half and a left half of the optical disk differ from each other in terms of the sensitivity of a recording film because of, such as irregularities or warpage in the optical disk, optimum recording power acquired through OPC does not mean true optimum recording power. Accordingly, at the time of selection of OPC areas, selecting OPC areas in such a way that the OPC areas are located essentially, uniformly over the entire circumference of the optical disk; namely, the entire perimeter of the optical disk, is desirable.

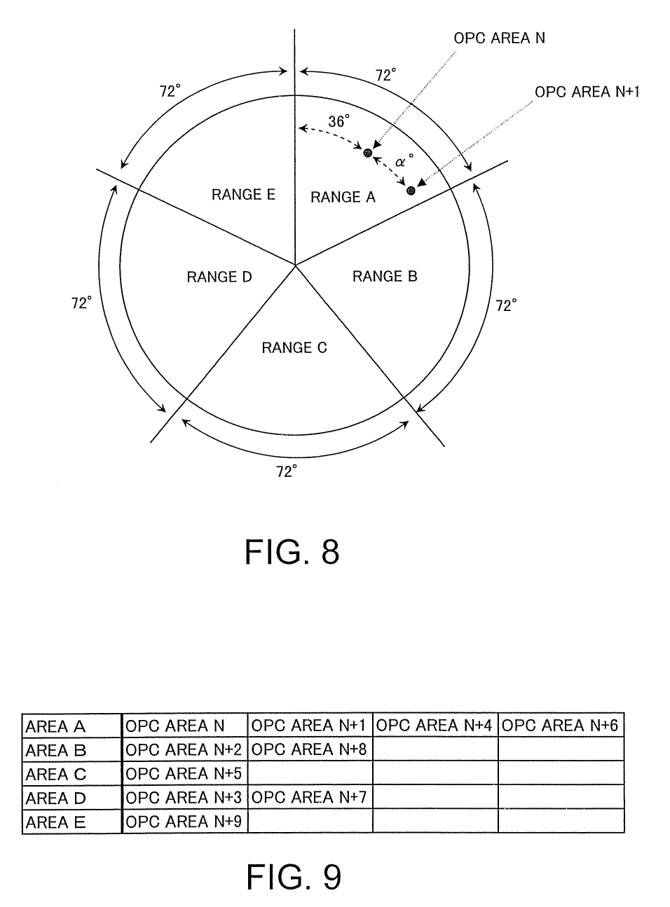

Specifically, OPC areas are selected as follows. When five OPC areas are selected, the entirety of the optical disk is virtually divided into five areas at every 72° with reference to the center of the disk; namely, ranges A to E, as shown in FIG. 8. When the optical disk is divided, the OPC area N is located at the center of the range A. The radius “r” of a track where the OPC area N is located is seen from an address of the OPC area N. Further, a distance L of a perimeter between the OPC area N and the OPC area N+1 is determined from the address of the OPC area N and the address of the OPC area N+1. Further, an angle a which the OPC area N forms with the OPC area N+1 can be computed from the radius “r” and the “distance L.” Thereby, the OPC area N and the OPC area N+1 can be determined to fall within which of the areas A to E. FIG. 9 shows an example determination rendered as mentioned above. The OPC areas N, N+1, N+4, and N+6 belong to the range A (area A), and the OPC areas N+2 and N+8 belong to the range B (area B). After the respective OPC areas have been determined to belong which of the ranges A to E, one OPC area having a small address is extracted from each of the ranges A to E.

Specifically,

the OPC area N is extracted from the range A;

the OPC area N+2 is extracted from the range B;

the OPC area N+5 is extracted from the range C;

the OPC area N+3 is extracted from the range D; and

the OPC area N+9 is extracted from the range E.

Test data are written, for a try, in the thus-extracted five OPC areas in sequence of the OPC area N, the OPC area N+2, the OPC area N+3, the OPC area N+5, and the OPC area N+9, and OPC is performed. As a result, OPC can be performed over the entire circumference of the optical disk, and optimum recording power determined by averaging variations in recording sensitivity of the optical disk can be set. As a matter of course, five OPC areas are illustrative, and an arbitrary number “n” (“n” is an integer of two or more) of OPC areas can be used. In this case, the essential requirement is to divide the optical disk into “n” areas with reference to the center of the disk and select one OPC area from each of the areas.

What is claimed is:

1. An optical disk drive that records data in each predetermined recording block which includes an APC area for use in controlling power, the drive comprising:
an irradiation section for emitting a recording laser beam; and
a power control section that emits the recording laser beam to the APC area of the recording block, to thus write test data for a try, and that controls recording power of the recording laser beam in accordance with quality of a reproduced signal obtained as a result of reproduction of the test data.

2. The optical disk drive according to claim 1, wherein the power control section writes the test data for a try at recording power that is determined by means of increasing or decreasing, by a predetermined amount, tentative optimum recording power responsive to recording linear speed achieved in a data record position.

3. The optical disk drive according to claim 1, wherein the power control section is for writing the test data for a try in the plurality of APC areas, and the plurality of APC areas are spread throughout an entire circumference of the optical disk.

4. The optical disk drive according to claim 1, wherein the power control section is for writing test data, for a try, in “n” APC areas (“n” is an integer of two or more); and the “n” APC areas are selected in such a way that one APC area is present in each of the “n” areas into which the optical disk has been divided with respect to a center of the optical disk.

5. An optical disk drive comprising:
a laser diode;
a drive section for driving the laser diode irrespective of data to be recorded, in order to compute a relationship between a drive current for the laser diode and a quantity of light emission in an APC area included in a recording block of an optical disk; and
a power control section that writes test data, for a try, in the APC area by means of driving a recording laser diode and that controls recording power of the laser diode in accordance with quality of a reproduced signal obtained as a result of reproduction of the test data.

6. The optical disk drive according to claim 5, wherein the power control section writes the test data, for a try, at recording power that is determined by means of increasing or decreasing, by a predetermined amount, tentative optimum recording power responsive to recording linear speed achieved at a data record position.

7. The optical disk drive according to claim 5, wherein the power control section is for writing the test data, for a try, in a plurality of APC areas, and the plurality of APC areas are spread over an entire circumference of the optical disk.

8. The optical disk drive according to claim 5, wherein the power control section is for writing test data, for a try, in “n” APC areas (“n” is an integer of two or more); and the “n” APC areas are selected in such a way that one APC area is present in each of the “n” areas into which the optical disk has been divided with respect to a center of the optical disk.
